(19) United States
(12) Patent Application Publication
(10) Pub. No.: US 2026/0077992 A1
(43) Pub. Date: Mar. 19, 2026

(54) BEVERAGE FLAVOR DOSING SYSTEM

(71) Applicant: PepsiCo, Inc., Purchase, NY (US)

(72) Inventors: Giancarlo FANTAPPIÈ, Rancho Palos Verdes, CA (US); Steven T. JERSEY, Laguna Niguel, CA (US); Diego MACRELLINO, Torrance, CA (US)

(21) Appl. No.: 19/399,081

(22) Filed: Nov. 24, 2025

Related U.S. Application Data
(63) Continuation of application No. 18/455,194, filed on Aug. 24, 2023, now Pat. No. 12,515,937.
(60) Provisional application No. 63/373,525, filed on Aug. 25, 2022.

(51) Int. Cl. B67D 1/00

(52) U.S. Cl. CPC B67D 1/0041; B67D 1/0051; B67D 1/0079; B67D 1/0085; B67D 2001/0088

(57) ABSTRACT

A flavor dispensing system includes a dispensing system configured to dispense flavor concentrates with minimal installation support. In aspects, the flavoring dispensing system includes one or more concentrate cartridges with a pump cap that are fluidly connected to a nozzle. A pump actuator in the flavor dispensing system moves the concentrate cartridges and thereby actuates the pump cap to dispense concentrate.

### CROSS-REFERENCE TO RELATED APPLICATIONS

This application claims the benefit of U.S. Provisional Application No. 63/373,525, filed Aug. 25, 2022 and is a continuation of U.S. application Ser. No. 18/455,194, filed Aug. 24, 2023, which are incorporated herein by reference in their entirety.

### FIELD

This disclosure relates to systems and methods for dispensing flavorings or other additives to beverages.

### BACKGROUND

Adding flavorings to a diluent, such as still water, to create a flavored beverage is a desirable way to create on-demand flavored beverages. However, in situations where there is an existing source of diluent, such as a plain water cooler or a sparkling water dispenser, adding the ability to dispense one or more flavorings in a simple and easy to use system is a desirable alternative to replacing the existing system with a more costly multi-beverage dispenser. Further, the ability to dispense flavorings should have minimal logistical requirements such as power, space, or plumbing requirements to improve installation flexibility. Existing solutions include having various bottles or packets of flavoring placed next to the water dispenser. But this solution requires considerable space to add multiple flavors, is not aesthetically pleasing, and does not allow for easy expansion for multiple flavorings or for fixed-dosing dispensing of the flavoring. Thus, there exists a need for an easy to use flavor dispensing apparatus that can be installed in a variety of environments and presents an improved user experience as compared to existing solutions.

### BRIEF SUMMARY

An aspect of a flavor dispenser includes a housing; a nozzle assembly extending from a front wall of the housing; a concentrate container disposed in a container holder inside the housing, the concentrate container fluidly connected to the nozzle assembly; a container cap disposed on an end of the concentrate container; a container holder disposed in the housing, the container holder configured to prevent a portion of the container cap from moving with respect to the container holder; and a pump disposed in the container cap and fluidly connected to an interior of the concentrate container; a pump actuator disposed in the housing configured to move a portion of the concentrate container with respect to the container holder, thereby actuating the pump.

Another aspect of a flavor dispenser includes a housing; a nozzle assembly extending from a front wall of the housing; a concentrate container disposed in a container holder inside the housing, the concentrate container fluidly connected to the nozzle assembly; a container cap disposed on an end of the concentrate container; a container holder disposed in the housing, the container holder configured to prevent a first portion of the container cap from moving with respect to the container holder; a pump disposed in the container cap and fluidly connected to an interior of the concentrate container, the pump formed by the first portion of the cap and a second portion of the cap slidably disposed around the first portion, wherein movement of the second portion with respect to the first portion pumps concentrate from an interior of the concentrate container through the container cap; and a pump actuator disposed in the housing configured to move a portion of the concentrate container with respect to the container holder, thereby actuating the pump.

### BRIEF DESCRIPTION OF THE DRAWINGS

The accompanying drawings, which are incorporated herein and form a part of the specification, illustrate the present disclosure and, together with the description, further serve to explain the principles thereof and to enable a person skilled in the pertinent art to make and use the same.

FIG. 1 is a front view of a flavor dispenser according to an aspect.

FIG. 2 is a side view of a flavor dispenser according to an aspect.

FIG. 3 is a perspective view of a dispensing system of a flavor dispenser according to an aspect.

FIG. 4 is a perspective view of a dispensing system of a flavor dispenser according to an aspect.

FIG. 5 is a rear view of a dispensing system of a flavor dispenser according to an aspect.

FIG. 6 is a side view of a concentrate container according to an aspect.

FIG. 7 is a cross section of a concentrate container cap according to an aspect.

FIG. 8 is a detail view of a pumping assembly according to an aspect.

### DETAILED DESCRIPTION

Reference will now be made in detail to representative aspects illustrated in the accompanying drawings. References to “one aspect,” “an aspect,” “an exemplary aspect,” etc., indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspect whether or not explicitly described.

An aspect of a flavor dispenser includes a housing; a nozzle assembly extending from a front wall of the housing; a concentrate container disposed in a container holder inside the housing, the concentrate container fluidly connected to the nozzle assembly; a container cap disposed on an end of the concentrate container; a container holder disposed in the housing, the container holder configured to prevent a portion of the container cap from moving with respect to the container holder; and a pump disposed in the container cap and fluidly connected to an interior of the concentrate container; and a pump actuator disposed in the housing configured to move a portion of the concentrate container with respect to the container holder, thereby actuating the pump.

This and other aspects disclosed here have several benefits. For example, this flavor dispenser is relatively compact and can be placed in a variety of locations, such as on a table top or mounted to a wall. It requires no plumbing connections, and in some aspects is powered by an onboard battery, and thus requires no external power connections. Other aspects of the flavor dispenser may have aa standard power connection, in addition to, or in place of, the battery. Thus, the flavor dispenser can be installed with minimal effort. It also presents an improved user experience in both ease of use and aesthetics. These and other benefits, and the structures and functions that enable these benefits, will be discussed in detail below.

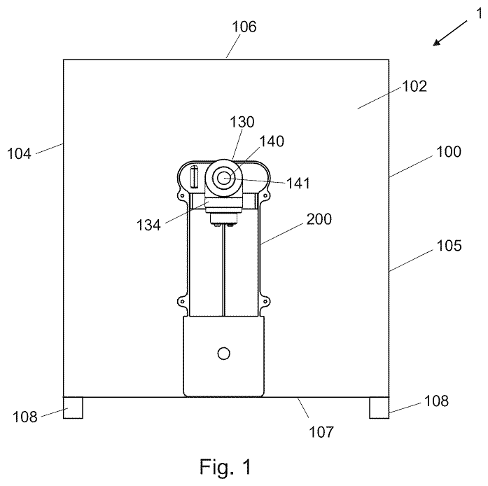

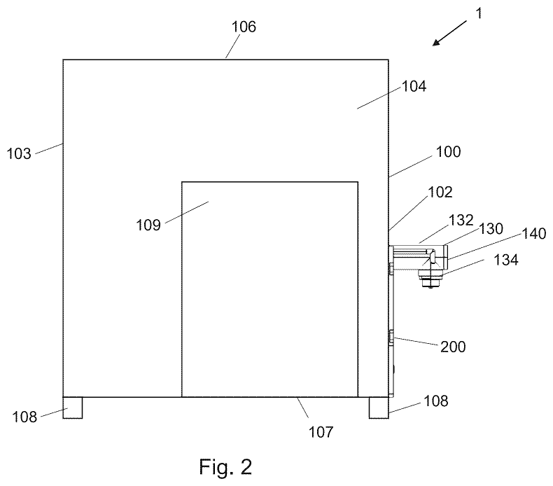

As shown in FIG. 1-2, a flavor dispenser 1 is formed with a housing 100. In an aspect, housing 100 can be formed as a rectangular prism with front wall 102, rear wall 103, left wall 104, right wall 105, top wall 106, and bottom wall 107 forming an enclosed space. In this aspect, feet 108 are attached to the bottom of housing 100 for placement of housing 100 on a horizontal surface, such as a tabletop. However, other aspects of housing 100 may not have feet 108, for example, for aspects of housing 100 that are intended for mounting to a vertical wall. In some aspects, feet 108 may be removable from housing 100 to enable housing 100 to be adapted to different mounting situations, including hung on a wall or on the cabinet of a water dispenser. Other aspects of housing 100 can be shaped in any desired enclosed form, including spherical, hexagonal, or other three-dimensional shapes.

As shown in FIG. 2, an access panel 109 is disposed in one of the walls of housing 100 (here, left wall 104). Access panel 109 can be disposed in any of the walls of housing 100, and there can be more than one access panel 109 in aspects of housing 100 depending on the need to access the interior of housing 100. Access panel 109 is a removable section of the corresponding wall that allows access into the interior of housing 100. Access panel 109 can be attached to housing 100 by any suitable method, including through mechanical fasteners, magnets, hinges, or snap fit attachments points. In some aspects, access panel 109 may include a locking element that prevents unauthorized access into the interior of housing 100.

As shown in FIG. 1, in an aspect front wall 102 of housing 100 may include a nozzle assembly 130. Nozzle assembly 130 dispenses concentrate to a user, as will be explained in detail below. As shown in FIG. 1, in an aspect nozzle assembly 130 is centered laterally (i.e., the direction between left wall 104 and right wall 105) on front wall 102. Centering nozzle assembly 130 in this way can present a pleasing appearance and improve user access. However, in other aspects, nozzle assembly 130 can be offset laterally or vertically as needed to accommodate design requirements.

In an aspect, a user interface 140 may be present on the exterior of flavor dispenser 1. For example, user interface 140 may comprise a button 141 disposed on nozzle assembly 130. Button 141 may be a mechanical button (i.e., a button that is spring loaded and is physically depressed), or button 141 may be a touch sensor. In any aspect, button 141 is activated by a user to activate flavor dispenser 1. Other aspects of user interface 140 can include a touchless sensor (e.g., a camera, laser, or other light-based sensor). In other aspects, user interface 140 may be disposed on other portions of housing 100 (e.g., any of front wall 102, rear wall 103, left wall 104, right wall 105, top wall 106).

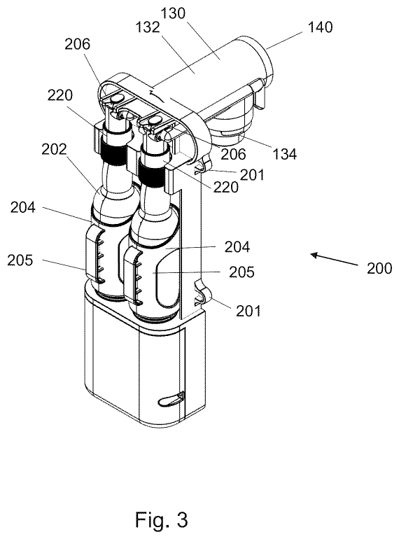

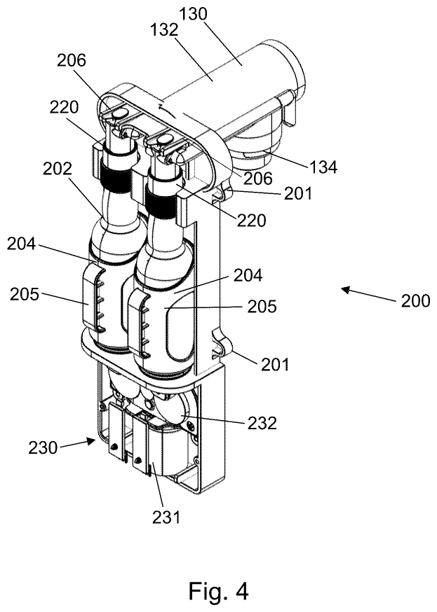

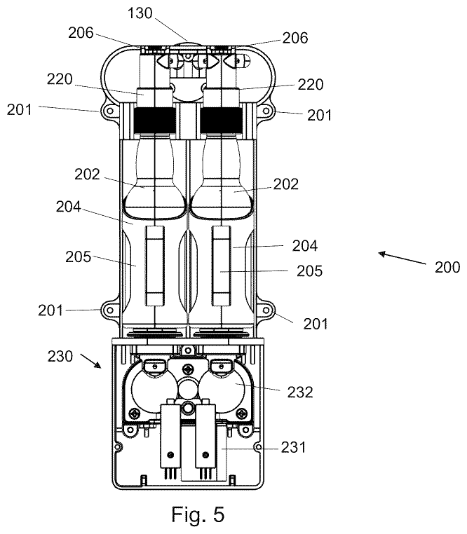

FIGS. 3-5 show a dispensing system 200 isolated from flavor dispenser 1. In the aspect shown in FIGS. 1-2, dispensing system 200 is integrated into standalone housing 100. However, it should be understood that dispensing system 200 can be integrated into an existing support surface, such as an existing beverage dispenser housing, wall, or cabinet. In this way, dispensing system 200 can enable the addition of flavor dispensing in an integrated manner without the need for a separate housing. To this end, dispensing system 200 may have attachment flanges 201 that are configured to enable attachment of dispensing system 200 to a suitable surface. For example, as shown in FIG. 3, attachment flanges 201 have holes that allow for use of mechanical fasteners for attachment of dispenser system 200.

In the aspect of FIGS. 3-5, a pair of concentrate containers 202 are releasably mounted in container holders 204. Other aspects of dispensing system 200 can include one, three, four, five, or more concentrate containers 202 and corresponding container holders 204. Concentrate containers 202 contain concentrates to be dispensed by flavor dispenser 1. For example, concentrates in concentrate containers 202 can include flavorings such as apple, orange, lemon, lime, grapefruit, caramel, and chocolate. Other concentrates can include drink supplements, water enhancers, or additives such as vitamins, minerals, and caffeine.

Container holders 204 are configured to releasably hold concentrate containers 202. In the aspect shown in FIG. 3-5, container holders 204 comprise a container receiver 205 that is cylindrically shaped with an opening that can receive concentrate container 202. Container holders 204 also include a cap holder 206. In the aspect shown, cap holder 206 is formed as a u-shaped protrusion that is configured to have a snap fit or press fit on container cap 220. In this way, concentrate container 202 is secured in cartridge holder 204 by the combination of being placed in container receiver 204 and then snapped into cap holder 206 (via cap 220 that is attached to the end of concentrate container 202). In these and other aspects of dispensing system 200, container holders 204 may be placed adjacent to each other such that the long axes of concentrate containers 200 are aligned and oriented vertically. This arrangement can reduce the footprint of flavor dispenser 1.

As shown in FIG. 3-6, nozzle assembly 130 is connected to dispensing system 200 to receive concentrate from concentrate container 204. As shown in FIG. 2-4, nozzle assembly 130 comprises a nozzle tube 132 extending outwards from dispensing system 200 (and the corresponding wall of housing 100). Nozzle tube 132 acts to support nozzle 134, which can be disposed at or near the distal end of nozzle tube 132. Nozzle 134 is configured to position and hold the end of a tube 136 that passes from dispensing system 200 through nozzle tube 132. In this way, nozzle 134 enables the dispensing of the concentrate from dispensing system 200.

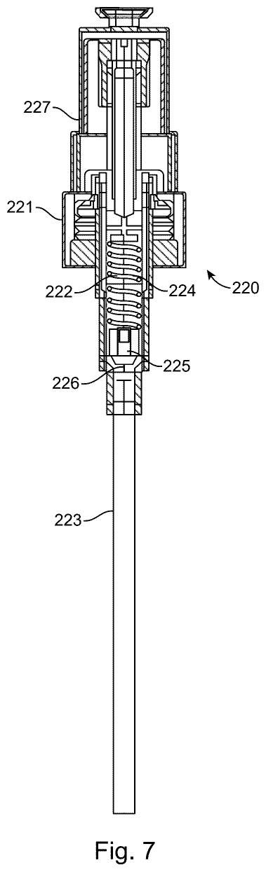

Dispensing system 200 is configured to dispense concentrate from concentrate containers 202 through nozzle assembly 130 to an end user. To do so, dispensing system 200 actuates or moves concentrate container 202 with respect to dispensing system 200. This motion actuates a pump 222 in FIG. 7 that is integrated into cap 220, which, in turn, pumps concentrate out of concentrate container 202 and through nozzle assembly 130 for dispensing.

In the aspect shown in FIG. 3-8, dispensing system 200 actuates concentrate containers 202 upwards (i.e., towards nozzle assembly 130). A portion of cap 220 is anchored by cap holder 206 and cannot move with respect to flavor dispensing system 200. This, in turn, means that the remaining elements of concentrate container 202 and cap 220 actuate upwards, thereby dispensing concentrate through pump 222 and into nozzle assembly 130. While this aspect of dispensing system 200 actuates concentrate container 202 upwards, a downwards actuation is also possible, either with the configuration shown in the figures (with concentrate container 202 below nozzle assembly 130) or with concentrate container 202 placed above nozzle assembly 130.

A cross-section of an aspect of cap 220 is shown in FIG. 7. Cap 220 includes a threaded base 221 configured to removably mate with an end of concentrate container 202. Thus, threaded base 221 is fixed to, and moves with, concentrate container 202. Pump 222 includes a tube 223 that extends into concentrate container 202 to provide a fluid connection to the concentrate. Pump 222 functions through the use of a spring 224 that pushes a ball 225 into a ball seat 226 at the upper (cap) end of tube 223. The upper portion 227 of cap 220 is slidably disposed in threaded base 221 and is fixed to tube 223, ball seat 226, spring 224, and ball 225. Spring 224 urges upper portion 227 upwards away from threaded base 221.

In operation, the upwards motion of upper portion 227 with respect to threaded base 221 acts to suction concentrate up tube 223 and into the passage surrounding spring 224 and ball 225. Downwards motion of upper portion 227 presses ball 225 into ball seat 226 at the top of tube 223, blocking fluid from flowing through tube 223. The downwards motion also reduces the space in the passage surrounding spring 224 and ball 225, which has the effect of pumping concentrate out of pump 222 through tube 136, which is fluidly connected to upper portion 227.

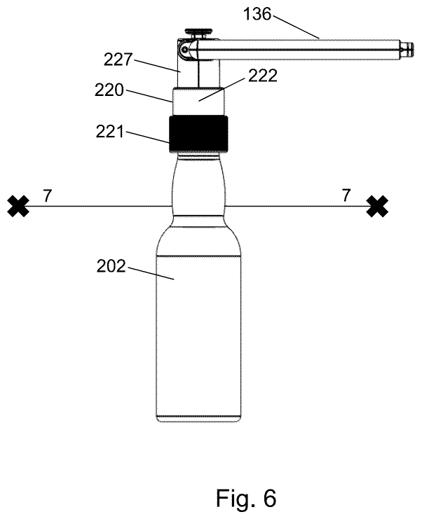

In some aspects, the connection between tube 136 and upper portion 227 can be fixed, for example, in the position shown in FIG. 6. In other aspects, tube 136 can be pivotally mounted to upper portion 227 such that it can pivot downwards (towards the bottom of FIG. 6) from the position shown in FIG. 6 to align with the long axis of concentrate container 202. This pivotal mounting can include an on/off feature in upper portion 227 that allows concentrate container to be fluidly connected or disconnected to tube 136 through the pivoting motion of tube 136.

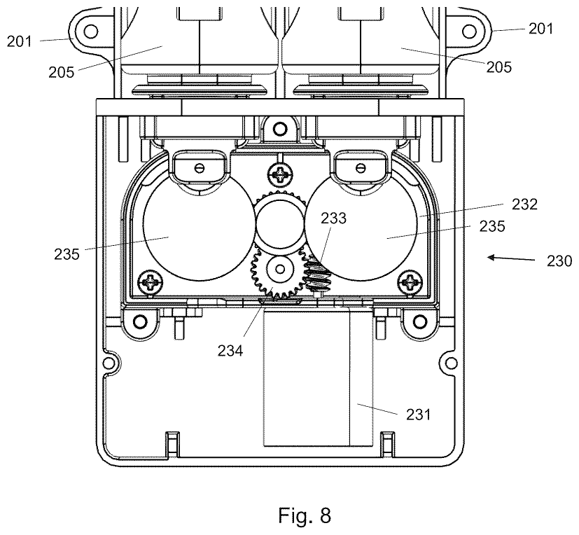

The motion of concentrate container 202 that actuates pump 220 is provided by pump actuator 230. A detail view of an aspect of pump actuator 230 is shown in FIG. 8. Certain components have been removed from FIG. 8 for clarity. This aspect of pump actuator 230 is disposed in the lower portion of dispensing system 200, immediately below container holders 204. A pump motor 231 is oriented vertically and disposed below gearbox 232. Pump motor 231 rotates a worm gear 233 that powers gearbox 232 by rotating a corresponding gear 234. The rotation of gear 234 powers the movement of concentrate plungers 235, each of which is associated with one of concentrate containers 202. Alternative aspects of pump actuator 230 can include, for example, linear actuators linked to the bottom of each concentrate containers 202 (via container holders 204) or a rack and pinion system that can move container holders 204 linearly in dispensing system 200.

Flavor dispenser 1 may be connected to the dispenser physically located near flavor dispenser 1 through a wireless connection (e.g., Bluetooth) or a hard wired connection (e.g., a USB cable). Flavor dispenser 1 can interface with this other dispenser and, through the other dispenser, can be connected to an external data network, the internet, or the cloud. Examples of functionality that can be enabled using this feature can include transmitting telemetry from flavor dispenser 1 that includes the onboard consumable state which can aid in replenishment and maintenance of flavor dispenser 1. Consumable tracking can be accomplished by tracking the number of dispenser cycles that have occurred since consumable replacement in flavor dispenser 1.

The structures described above can be made from any suitable material, including, for example, metal, plastics, composites, wood, fiber materials, or a combination thereof. In some aspects, housing 100 is made from plastic or metal materials painted, dyed, or coated in a desirable color scheme.

An aspect of a method of operation of flavor dispenser 1 begins with loading concentrate containers 202 into container holders 204 via access hatch 109. If necessary, tube 136 is pivoted into the activated position to ensure concentrate can flow from concentrate container 202. After access hatch 109 is replaced, flavor dispenser 1 can be placed into operation by connecting flavor dispenser 1 to a suitable power source. A user activates flavor dispenser 1 to dispense a desired concentrate. Pump actuator 230 actuates the corresponding pump motor 231, which, through gearbox 232, displaces the correct concentrate container 202 upwards. This motion, in turn, actuates pump 222 in cap 220 to push concentrate into tube 136 and out of nozzle 130 for dispensing.

It is to be appreciated that the Detailed Description section, and not the Summary and Abstract sections, is intended to be used to interpret the claims. The Summary and Abstract sections may set forth one or more but not all exemplary aspects of the present invention(s) as contemplated by the inventors, and thus, are not intended to limit the present invention(s) and the appended claims in any way.

The foregoing description of the specific aspects will so fully reveal the general nature of the invention(s) that others can, by applying knowledge within the skill of the art, readily modify or adapt for various applications such specific aspects, without undue experimentation, and without departing from the general concept of the present invention(s). Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance herein.

The breadth and scope of the present invention(s) should not be limited by any of the above-described exemplary aspects, but should be defined only in accordance with the following claims and their equivalents.

What is claimed is:

1. A method of dispensing a beverage concentrate from a dispensing system, the method comprising:
providing a container holder disposed in a housing of the dispensing system;
receiving a concentrate container in the container holder, the concentrate container comprising a container cap having a first portion that is received by the container holder to prevent movement of the first portion with respect to the container holder;
moving a second portion of the container cap with respect to the first portion using a pump actuator disposed in the housing;
actuating a pump disposed in the container cap by the relative movement of the first portion and the second portion, the pump fluidly connected to an interior of the concentrate container; and
dispensing a concentrate out of a nozzle assembly through a tube fluidly connected to the container cap using the pump, wherein the tube is pivotally connected to an exterior of the container cap such that the tube can be pivoted between a first position where the tube is fluidly connected to an interior of the concentrate container and a second position where the tube is not fluidly connected to an interior of the concentrate container.

2. The method of claim 1, wherein the dispensing system does not require connection to an external source of diluent.

3. The method of claim 1, further comprising:
providing a second container holder disposed in the housing of the dispensing system;
receiving a second concentrate container in the container holder, the second concentrate container comprising a second container cap having a first portion that is received by the second container holder to prevent movement of the first portion with respect to the second container holder;
moving a second portion of the second container cap with respect to the first portion using the pump actuator disposed in the housing;
actuating a second pump disposed in the second container cap by the relative movement of the first portion and the second portion, the second pump fluidly connected to an interior of the second concentrate container.

4. The method of claim 1, wherein the nozzle assembly comprises a nozzle tube that extends from the front wall of the housing, and a nozzle disposed near a distal end of the nozzle tube, the nozzle configured to dispense concentrate.

5. A method of dispensing a beverage concentrate from a dispensing system, the method comprising:
providing a first container holder and a second container holder disposed in a housing of the dispensing system;
receiving a first concentrate container in the first container holder, the first concentrate container comprising a first container cap having a first portion that is received by the first container holder to prevent movement of the first portion with respect to the first container holder;
receiving a second concentrate container in the second container holder, the second concentrate container comprising a second container cap having a first portion that is received by the second container holder to prevent movement of the first portion with respect to the second container holder;
moving a second portion of the first container cap with respect to the first portion using a pump actuator disposed in the housing;
actuating a pump disposed in the second container cap by the relative movement of the first portion and the second portion of the first container cap, the pump fluidly connected to an interior of the concentrate container;
moving a second portion of the first container cap with respect to the first portion using a pump actuator disposed in the housing; and
actuating a pump disposed in the second container cap by the relative movement of the first portion and the second portion, the pump fluidly connected to an interior of the concentrate container.

6. The method of claim 5, wherein one of the first container cap and the second container cap comprises a tube that is pivotally connected to an exterior of the one of the first container cap and the second container cap such that the tube can be pivoted between a first position where the tube is fluidly connected to an interior of the corresponding concentrate container and a second position where the tube is not fluidly connected to an interior of the corresponding concentrate container.

7. The method of claim 5, wherein the dispensing system does not require connection to an external source of diluent.

8. The method of claim 5, further comprising dispensing concentrate from one of the first concentrate container and the second concentrate container by passing the concentrate through a nozzle assembly, wherein the nozzle assembly comprises a nozzle tube that extends from the front wall of the housing, and a nozzle disposed near a distal end of the nozzle tube, the nozzle configured to dispense concentrate.

9. A method of dispensing a beverage concentrate from a dispensing system, the method comprising:
providing a container holder disposed in a housing of the dispensing system;
receiving a concentrate container in the container holder, the concentrate container comprising a container cap having a first portion that is received by the container holder to prevent movement of the first portion with respect to the container holder;
moving a second portion of the container cap with respect to the first portion using a pump actuator disposed in the housing;
actuating a pump disposed in the container cap by the relative movement of the first portion and the second portion, the pump fluidly connected to an interior of the concentrate container, the pump formed by the first portion of the container cap and the second portion of the container cap slidably disposed around the first portion, wherein movement of the second portion with respect to the first portion pumps concentrate from an interior of the concentrate container through the container cap; and
dispensing a concentrate out of a nozzle assembly through a tube fluidly connected to the container cap using the pump, wherein the tube is pivotally connected to an exterior of the container cap such that the tube can be pivoted between a first position where the tube is fluidly connected to an interior of the concentrate container and a second position where the tube is not fluidly connected to an interior of the concentrate container.

10. The method of claim 9, wherein the dispensing system does not require connection to an external source of diluent.

11. The method of claim 9, further comprising:
providing a second container holder disposed in the housing of the dispensing system;
receiving a second concentrate container in the container holder, the second concentrate container comprising a second container cap having a first portion that is received by the second container holder to prevent movement of the first portion with respect to the second container holder;
moving a second portion of the second container cap with respect to the first portion using the pump actuator disposed in the housing;
actuating a second pump disposed in the second container cap by the relative movement of the first portion and the second portion, the second pump fluidly connected to an interior of the second concentrate container.

12. The method of claim 9, wherein the nozzle assembly comprises a nozzle tube that extends from the front wall of the housing, and a nozzle disposed near a distal end of the nozzle tube, the nozzle configured to dispense concentrate.
